(19) United States
(12) Patent Application Publication
(10) Pub. No.: US 2005/0114039 A1
(43) Pub. Date: May 26, 2005

(54) Interruption of batch processing for high priority processing

(76) Inventors: Craig Kennedy, Dayton, OH (US); Thomas Fister, Lebanon, OH (US); Telford Berkey, London, OH (US); Daniel Corwin-Renner, Ann Arbor, MI (US); Peter Farrell, Dundas (CA)

Correspondence Address: DINSMORE & SHOHL LLP;One Dayton Centre, Suite 1300, One South Main Street, Dayton, OH, 45402-2023, US

(21) Appl. No.: 10/993,190

(22) Filed: Nov. 19, 2004

Related U.S. Application Data
(60) Provisional application No. 60/525,207, filed on Nov. 26, 2003.

(51) Int. Cl. G06K 1/00; G06F 15/00; G06F 19/00

(52) U.S. Cl. 702/19; 382/128; 600/300

(57) ABSTRACT

Computer-aided detection (CAD) systems are now commonly used in both screening and diagnostic mammography. As the number of cases processed by CAD systems increase, new functionality must be added to provide efficient processing. This invention provides the capability to interrupt a batch processing run allowing a high priority case to be processed before the expected completion of the batch run. Upon completion of the high priority case, the batch processing continues from the point of interruption with minimal user intervention.

### CROSS-REFERENCE TO RELATED APPLICATIONS

This application claims the benefit of U.S. Provisional Application No. 60/525,207, filed Nov. 26, 2003, incorporated herein by reference.

### BACKGROUND OF THE INVENTION

1. Field of the Invention

The present invention generally relates to computer-aided detection (CAD) systems for providing assistance in locating suspicious regions in medical imagery and, in particular, relates to the orderly insertion of a high priority case into a batch of cases currently scheduled for processing.

2. Discussion of Background

Computer-aided detection (CAD) systems are now commonly used in both screening and diagnostic mammography. FIG. 1 illustrates a high level block diagram of a typical CAD system. The standard workflow in a mammography center begins with a radiology technologist entering patient identification information into an electronic system 100, such as a computer. The technologist then positions the patient in the mammography x-ray device and exposes four films, collectively referred to as a case. The films include two views of each breast, the cranio-caudal (CC) and medial-lateral oblique (MLO). Before development, patient information may be “flashed” onto the films. The films are then developed and inspected to ensure compliance with the Mammographic Quality Standards Act (MQSA). MQSA compliant cases are then loaded into the digitizer 101 of a CAD system by the radiology technician. The technologist uses interface devices 105 such as a keyboard, mouse, touch screen, bar code reader, or speech recognition application to control the CAD system operation and input patient identification information. The digitizer 101 feeds the films one at a time, creating a set of four digital images. These digital images are analyzed for signs of cancer by algorithms in the CAD system.

The CAD system produces a visual or textual indication of the location and type of cancer indicator suspected. The output is typically either a printed page from a printer 115 or electronic file stored in storage 110 consisting of the digital mammogram images with suspicious regions highlighted by markers; different marker styles are used to denote different indicators of cancer. When the CAD output is a printed page, it may be stored with the films. When the CAD output is an electronic file, it is stored and recorded such that it may be recalled using patient identification information and subsequently printed or displayed on a monitor, 120. A radiologist then uses the CAD output during an interpretation phase.

To maximize technologist productivity arid efficiency, it is desirable to accumulate a number of cases before CAD processing. Typically, the collection of cases will require many hours, even on the order of an overnight's amount of time, to process. Currently, the time required to process a standard four-film case ranges from four to six minutes.

Assuming fourteen hours are available in an overnight interval, 210 to 140 cases may be processed in an otherwise unused time span. Films from a collection of cases are loaded into the digitizer 101. Corresponding patient information is then entered for each case to create a worklist. Then, commands are input to the CAD system 100 to begin processing in the “batch” mode. The cases are processed sequentially, producing a collection of CAD outputs sent to either the printer 115 or to storage 110. The next morning, the processing is complete, with CAD findings being associated with the corresponding patient information. For systems creating paper output, the pages are associated with the proper films for subsequent use by a radiologist.

Occasionally, a user may need to obtain CAD results in a relatively short time interval for a high priority case not currently in the batch while a batch process is running. Accordingly, a method and system are needed to allow for the interruption of a CAD system's batch process to obtain timely processing of this high priority case.

Therefore, there is a need for the efficient and orderly insertion of a high priority case into a CAD system batch processing job so that the high priority case is processed before the cases remaining in the batch processing job.

### SUMMARY OF THE INVENTION

According to the present invention, a CAD system processes a worklist with at least one case of normal priority remaining. A user signals to the CAD system that a higher priority case not currently in the worklist will be input. The CAD system halts the process. The higher priority case is loaded into digitizer and processed by the CAD system, producing a CAD system output for the higher priority case. After processing the higher priority case, normal processing resumes for the cases remaining in the worklist.

Accordingly, it is an object of the present invention to interrupt a batch processing run to allow a high priority case to be processed before the expected completion of the batch run.

Other objects and advantages of the present invention will be apparent in light of the following description of the invention embodied herein.

### BRIEF DESCRIPTION OF THE DRAWINGS

The following detailed description of specific embodiments of the present invention can be best understood when read in conjunction with the following drawings, where like structure is indicated with like reference numerals, and in which:

FIG. 1 is a high level block diagram of a typical CAD system;

FIG. 2 illustrates a main screen of an interface to a CAD system according to an embodiment of the present invention;

FIG. 3 illustrates a main screen of an interface to a CAD system prompting the user to load the appropriate film according to an embodiment of the present invention;

FIG. 4 illustrates a main screen of an interface to a CAD system after the user loads the film according to an embodiment of the present invention;

FIG. 5 illustrates a main screen of an interface to a CAD system while the state case is processing according to an embodiment of the present invention; and

FIG. 6 illustrates a main screen of an interface to a CAD system indicating to the user that the stat case has completed processing according to an embodiment of the present invention.

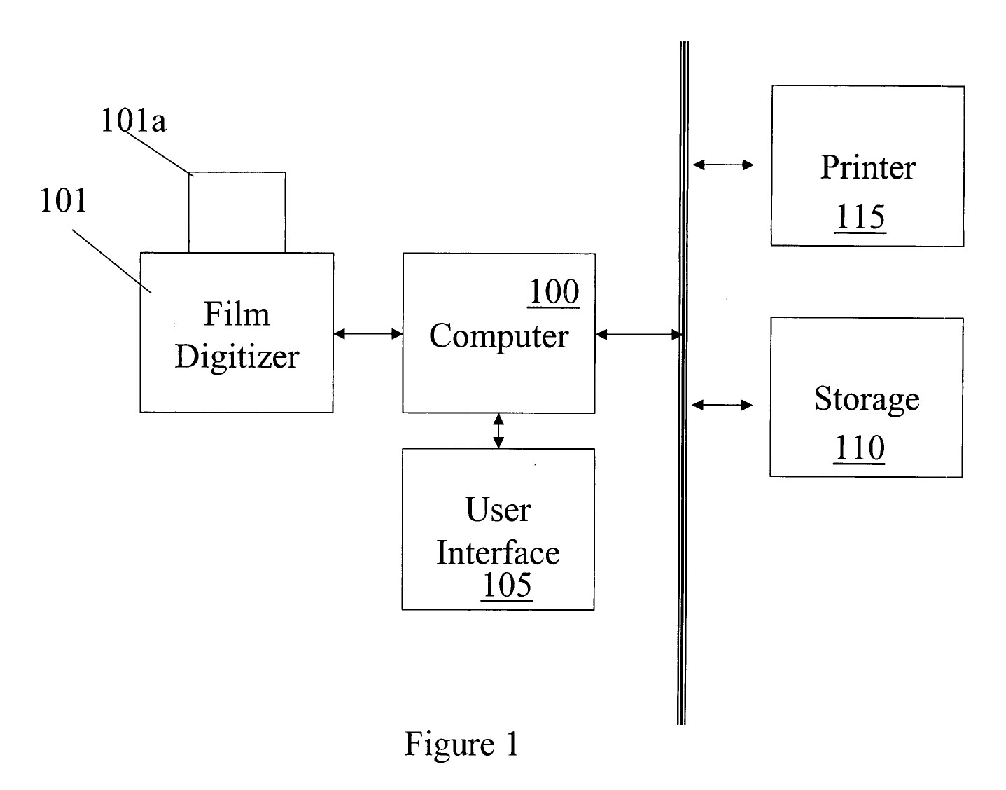

### DETAILED DESCRIPTION OF THE PREFERRED EMBODIMENTS

In the following detailed description of the preferred embodiments, reference is made to the accompanying drawings that form a part hereof, and in which are shown by way of illustration, and not by way of limitation, specific preferred embodiments in which the invention may be practiced. It is to be understood that other embodiments may be utilized and that logical, mechanical and electrical changes may be made without departing from the spirit and scope of the present invention.

This invention provides a method and system for the efficient and orderly insertion of a high priority case into a CAD system batch processing job that is currently running. A high priority case is referred to as a “stat” case. Among medical personnel, a word commonly used to indicate a time critical activity is “stat,” an abbreviated form of the Latin word statim, for “immediately.” A user interface allows the batch processing to be halted, a stat case to be added to the queue and processed before the remaining cases in the batch. The batch processing resumes automatically upon completion of the stat case.

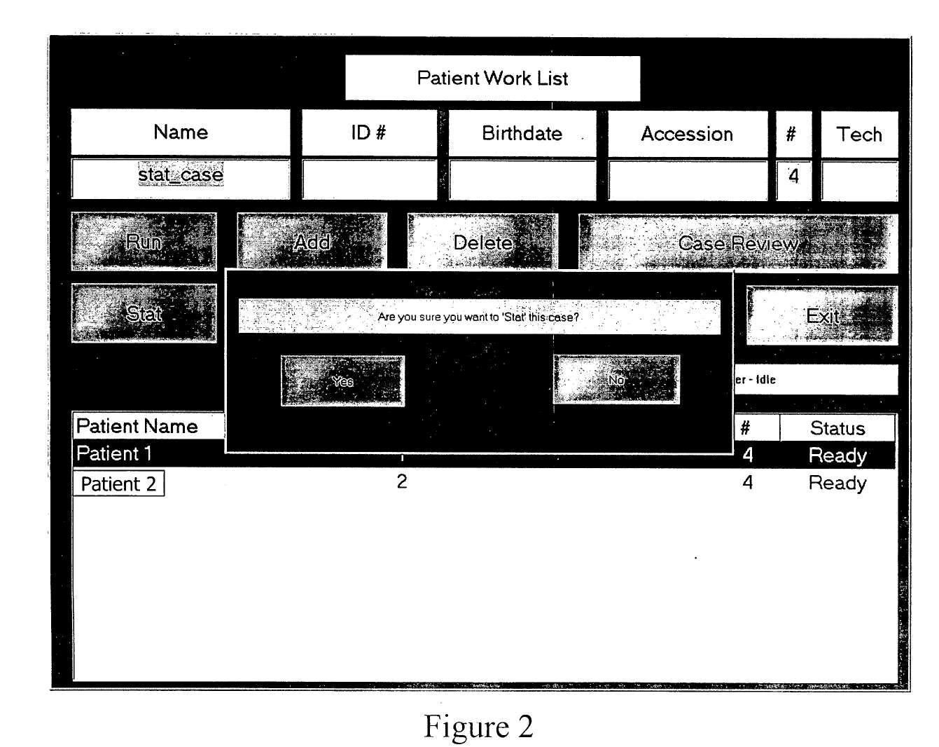

FIG. 2 illustrates the main screen of a graphical user interface to a CAD system. The user has previously entered a worklist, or batch run, for patients named “Patient 1” and “Patient 2” as shown under the Patient Name heading; the Status of these cases is shown as Ready. The user has subsequently requested stat processing for a patient named “stat_case”.

In the center of the FIG. 2 a pop up message box is displayed requesting confirmation from the user that stat processing is desired for the case of films from the patient whose name is in the “Name” field. If a case is currently being processed when the “Stat” button is selected, the stat case will be processed upon completion of the currently processed case.

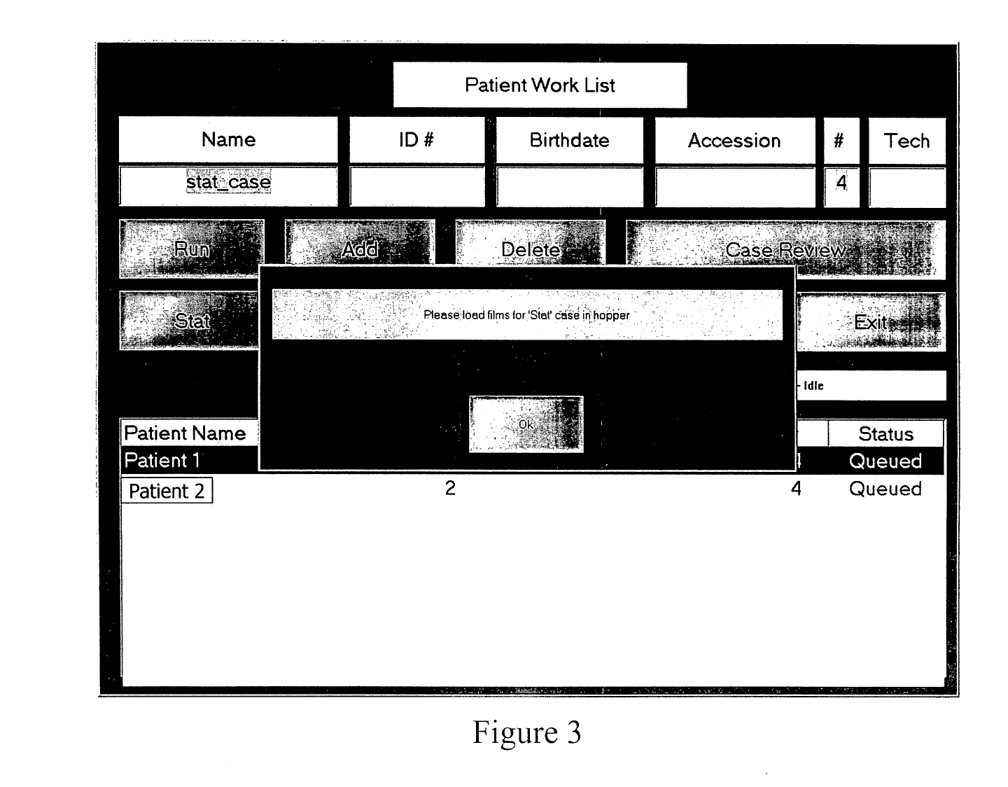

After the user confirms that stat processing is desired, the status of cases in the batch run for patients 1 and 2 changes to “Queued” and the system prompts the user to load the appropriate films of the stat case, as shown in FIG. 3. After the films are loaded, the user clicks the “Ok” button.

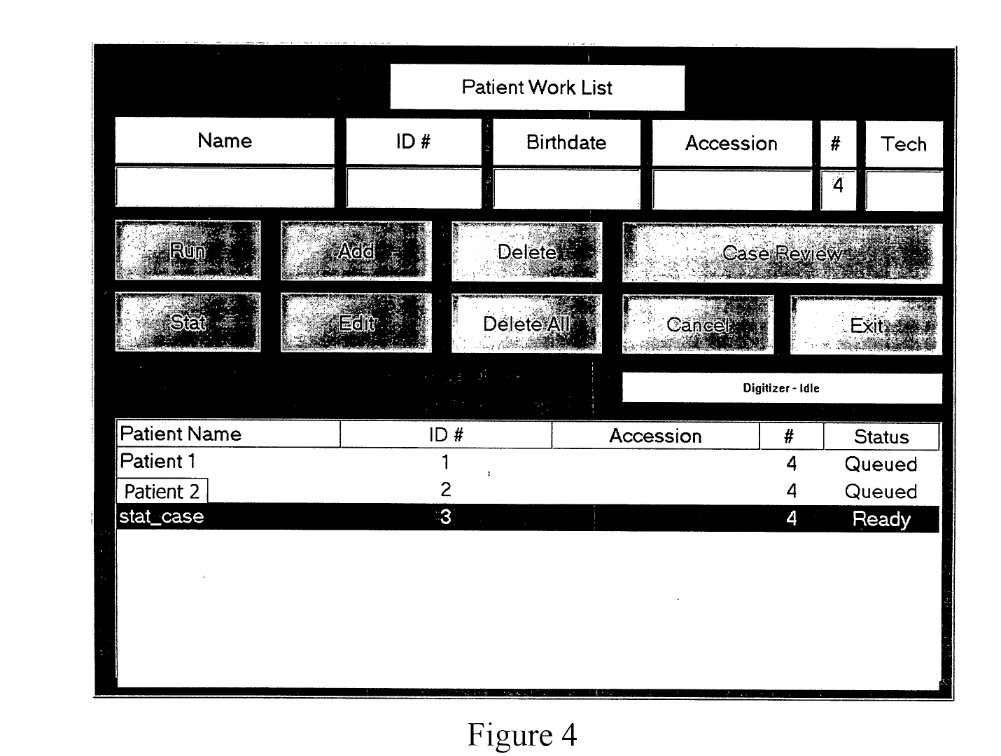

FIG. 4 illustrates the screen of the CAD system displayed after the user loads the stat case films and selects the “Ok” button. The stat case is shown at the bottom of the patient name list, and its status is shown as “Ready”. At this time, the user selects the “Run” button in the upper left portion of the graphical user interface to begin processing of the stat case.

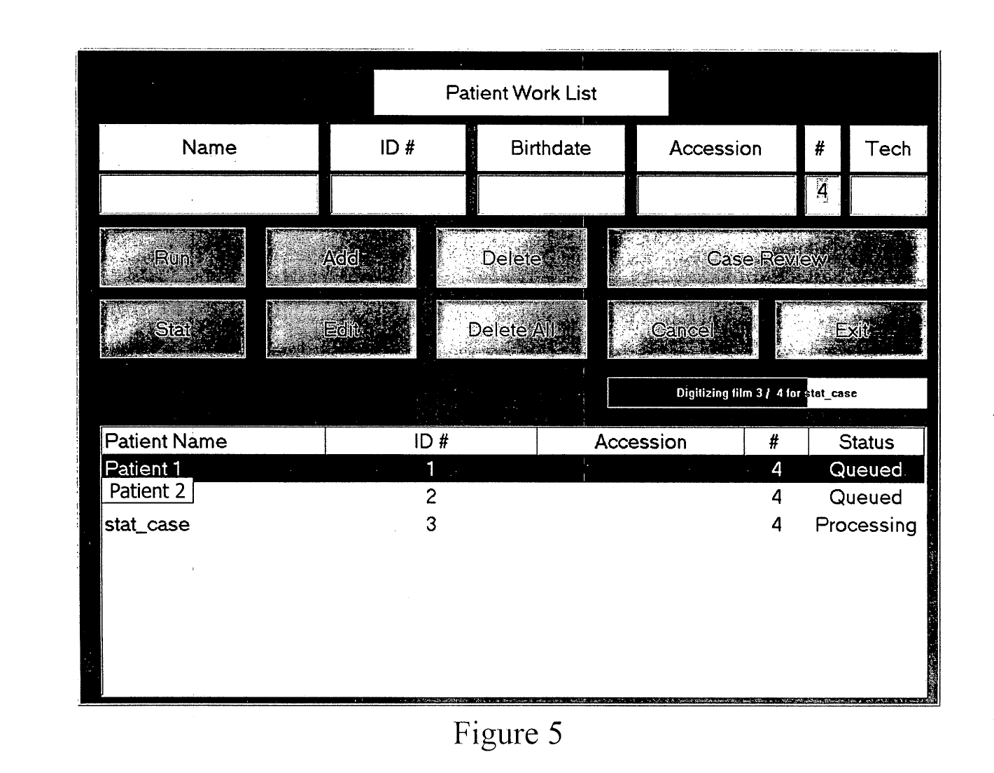

FIG. 5 illustrates the screen of the CAD system that is displayed while the stat case is being processed. In this example, the status of the stat case is shown as “Processing” and the digitizer progress bar field illustrates that the third of the four films in the case is being digitized. In one embodiment, when the stat case completes processing, the queued cases in the batch run resume processing without user intervention.

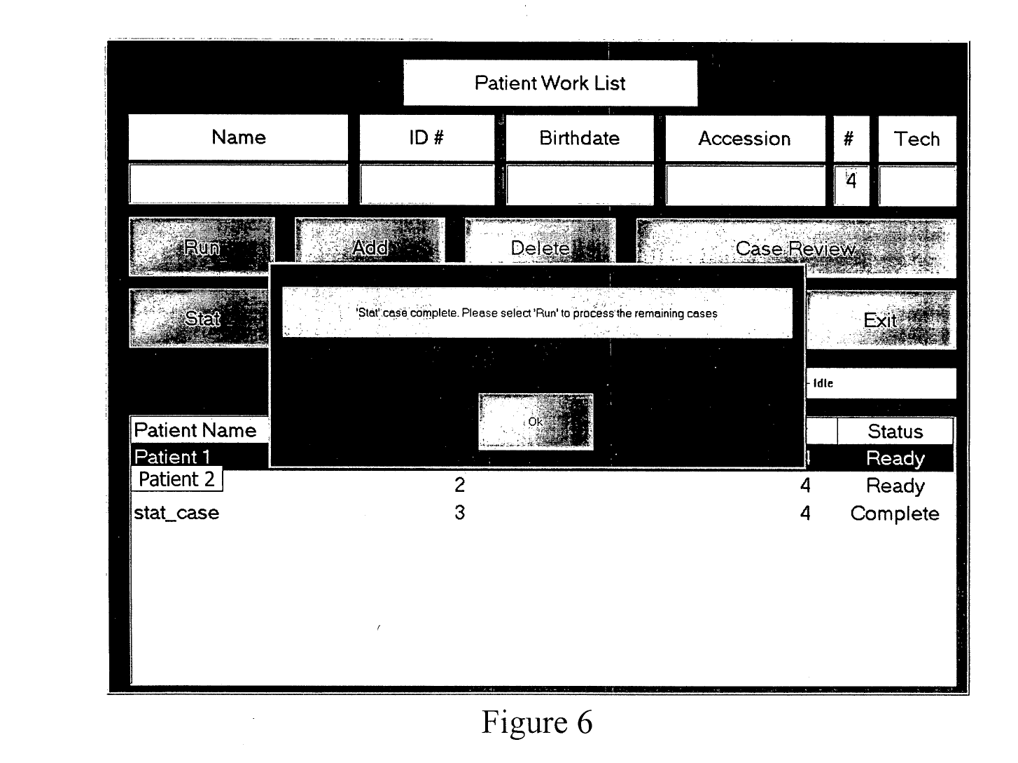

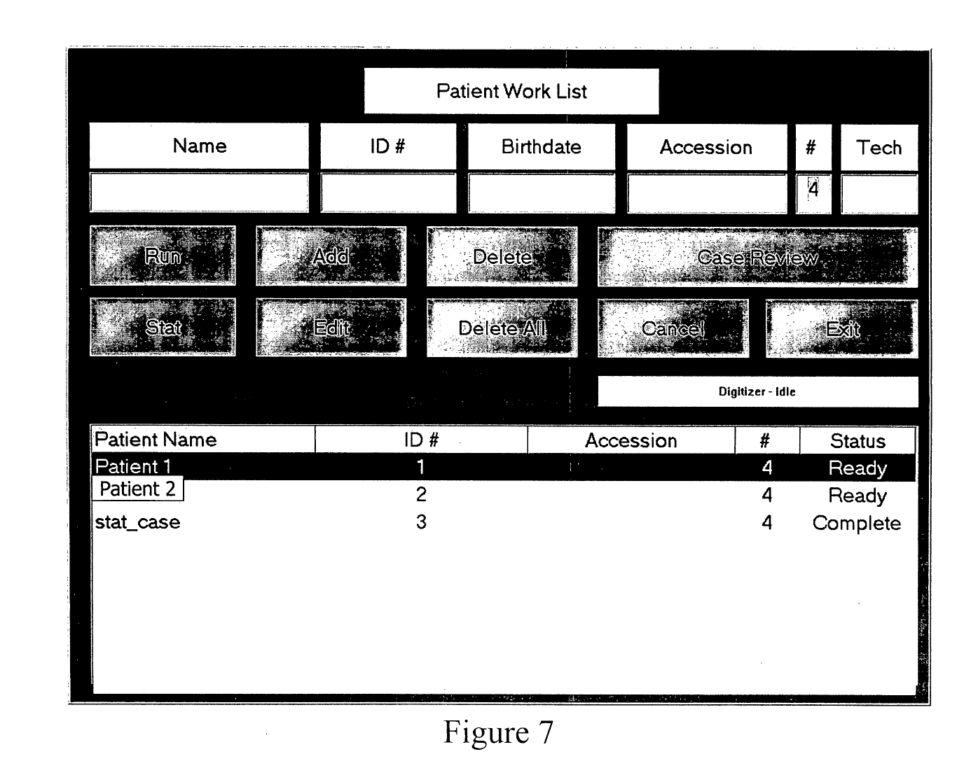

In an alternative embodiment, the user can confirm the resumption of processing via a message box as shown in FIG. 6. Here, the message shows that the stat case is completed. Additionally, the status of the stat case is now displayed as “Complete” and the status of the cases for patients 1 and 2 is changes to “Ready.” A pop up message instructs the user to select “Run” to resume processing of the remaining cases.

### Case Separators for Identification of a “Stat” Case

CAD systems may also operate with “case separators” between the films for different patients. Operating a CAD system with case separators allows users to avoid the step of counting the number of medical films associated with a patient's case. A case separator is a specially designed film with a computer-readable marking that allows it to be readily identified as such. The marking is designed such that case separators are reliably detected and simultaneously, medical image films are not misidentified as a case separator. For example, a case separator could be a clear plastic film with an affixed bar code label in a predetermined location carrying the text string “CASE SEPARATOR”. Upon digitization of the film, which is either a medical image or a case separator, the pixels corresponding to the predetermined location are decoded with a bar code reading application. When the decoded string is “CASE SEPARATOR”, a case separator is detected.

A stat case separator is a special type of case separator with a design that when decoded causes stat processing to be initiated. A stat case separator can be a clear film with an affixed bar code label carrying the text string “STAT CASE”. In practice, an user would place a first stat case separator on top of a collection of films comprising a stat case and a second stat case separator below the collection to signify the end of the stat case. The films processed between the first and second stat case separators comprise the stat case. Then, the user places this group into the hopper of the CAD system digitizer such that the first stat case separator will be the next film digitized. When the first stat case separator is detected, the case currently under processing is queued. Then, the image films in the stat case collection are digitized and processed until the second stat case separator is detected. In another embodiment, stat case labels are used in lieu of stat case separators and affixed directly to medical image films. In this embodiment, the operator also enters the number of films comprising the stat case.

Two options are supported for stat case insertion. In the first option, the stat group is inserted between the last film of a first case and the first film of a second case. This allows the first case to complete processing before processing is initiated on the stat case. The stat case is processed and its CAD system output obtained. Then, processing resumes with the second case.

In the second option, the stat case can be inserted in the front of the hopper of the CAD system digitizer, even if a case is currently being processed. In this option, the stat case is inserted between films of a case. In this situation, the queuing requires storing the intermediate image-based CAD results for the films having already been processed of the case being processed and associating the image based results with the patient's name. The stat case is processed and its CAD system output created. The system resumes operation by recalling the queued image-based CAD results and digitizing and processing any remaining films in the interrupted case. After completion of the interrupted case, remaining cases in the queue are processed by the CAD system.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A method for providing computer-aided detection processing for a high priority case during ongoing computational processing of a set of normal priority cases comprising:
signaling to said computer-aided detection system that high priority processing is desired;
halting said ongoing computational process;
providing said high priority case as input to a digitizer of a computer-aided detection system such that said high priority case will be processed next;
processing said high priority case to provide a computer-aided detection system output for said high priority case; and
resuming said halted computational process.

2. The method of claim 1, further comprising:
displaying status of said ongoing computational process of said high priority case and said set of normal priority cases.

3. The method of claim 2, wherein said status is displayed on an output device.

4. The method of claim 3, wherein said output device comprises one of a computer monitor, a LCD flat screen, a CRT monitor, a plasma screen or combinations thereof.

5. The method of claim 1, wherein said high priority case comprises at least one film medical image.

6. The method of claim 5, wherein said film medical image is a mammogram image.

7. The method of claim 1, wherein signaling further comprises receiving input from a user interface of said computer-aided detection system to alert said computer-aided detection system of said high priority case.

8. The method of claim 7, wherein said user interface comprises one of a keyboard, a mouse, a touch screen, a barcode reader, a speech recognition application, or combinations thereof.

9. The method of claim 1, wherein signaling further comprising:
providing a film having a computer-identifiable marker associated with high priority case processing;
digitizing the film having said computer-identifiable marker to create a digital image; and
analyzing said digital image to detect said computer-identifiable marker associated with high priority case processing.

10. The method of claim 1, wherein halting further comprises:
prompting a user to insert said high priority case as input into said digitizer.

11. The method of claim 1, wherein halting further comprises:
notifying an operator to wait for an ongoing digitization to complete.

12. The method of claim 1, wherein halting further comprises:
waiting for completion of the processing of the current normal priority case of said set of normal priority cases before halting said ongoing computational process; and
notifying a user to input said high priority case into said digitizer after completion of said processing of said current normal priority case of said set of normal priority cases.

13. The method of claim 12, wherein notifying comprises displaying a pop-up message box on an output device of said computer-aided detection system.

14. The method of claim 1, wherein resuming further comprises receiving input from a user interface of said computer-aided detection system to resume processing said set of normal priority cases.

15. The method of claim 1, wherein said computer-aided detection system output is paper printed by a printer.

16. The method of claim 1, wherein said outputted paper is stored with the associated medical image films of its processed case.

17. The method of claim 1, wherein said computer-aided detection system output is an electronic file.

18. The method of claim 17, wherein said electronic file is stored electronically with identification information for later retrieval.

19. A method for identifying a high priority case of medical image films by forming a group of films comprising:
providing a first film with a computer-identifiable marker associated with said high priority case;
providing a set of medical image films associated with said high priority case; and
providing a second film with a computer-identifiable marker associated with said high priority case.

20. The method of claim 19, wherein said computer-identifiable marker is an affixed bar code label.

21. A method for identifying a high priority case of medical image films by forming a group of films comprising:
affixing a computer-identifiable marker associated with said high priority case to a first medical image film; and
affixing a computer-identifiable marker associated with said high priority case to a second medical image film.

22. The method of claim 21, wherein said computer-identifiable marker is a bar code label.

23. The method of claim 21, further comprising including one or more medical film images between said first medical image film and said second medical image film.

24. A method for providing computer-aided detection processing for a high priority case during ongoing computational processing of a set of normal priority cases comprising:
signaling to said computer-aided detection system that high priority processing is desired;
halting said ongoing computational process;
storing said ongoing computational process of said normal priority case that is currently in progress;
providing said high priority case as input to a digitizer of a computer-aided detection system such that said high priority case will be processed next;
processing said high priority case to provide a computer-aided detection system output for said high priority case;
recalling and processing said stored ongoing computational process of said normal priority case; and
resuming said computational process of said remaining set of normal priority cases.

25. A method for providing computer-aided detection processing for a high priority case contained within a set of normal priority cases during ongoing computational processing comprising:
signaling to said computer-aided detection system that high priority processing is desired for a specific case contained within said set of normal priority cases;
halting said ongoing computational process;
alerting a user to input said specific high priority case in a digitizer of said computer-aided detection system;
providing said specific high priority case as input to said digitizer of said computer-aided detection system such that said specific high priority case will be processed next;
processing said specific high priority case after user interact indicating the readiness of said input to said digitizer to provide a computer-aided detection system output for said specific high priority case;
deleting said specific high priority case from said set of normal priority cases; and
resuming said halted computational process of said set of normal priority cases.

26. A system for providing computer-aided detection system processing for a high priority case during ongoing computational processing of a set of normal priority cases comprising:
user interface to signal to a computer-aided detection system that a high priority case processing is desired;
a digitizer of said computer-aided detection system to receive as input said high priority case; and
a processor of said computer-aided detection system to obtain said signal from said user interface, to halt said ongoing computational process, to receive said high priority case input from said digitizer, and to process said high priority case input.

27. The system of claim 26, further comprising:
an output device to provide computer-aided detection system output for said high priority case.

28. The system of claim 27, wherein said output device is a printer.

29. The system of claim 27, wherein said output device is an electronic storage device.

30. A method for providing computer-aided detection processing for a high priority case during ongoing computational processing of a set of normal priority cases comprising:
accepting user input designating that high priority processing is desired for said high priority case;
accepting user input specifying the number of medical image films comprising said high priority case;
affixing a computer-identifiable marker associated with said high priority processing to a first medical image film of said high priority case; and
providing said first medical image film and other medical image films associated with said high priority case to a computer-aided detection system such that said high priority case will be processed next.

31. The method of claim 30, further comprising:
halting said ongoing computational process; and
processing said high priority case to provide a computer-aided detection system output for said high priority case.

32. The method of claim 31, further comprising:
resuming said halted computational process.
